(19) United States
(12) Patent Application Publication
(10) Pub. No.: US 2011/0200861 A1
(43) Pub. Date: Aug. 18, 2011

(54) HEAT-DISSIPATING MODLUE FOR AUTOMOBILE BATTERY

(75) Inventor: Yu-Min Lin, Sinjhuang City (TW)

(73) Assignee: ASIA VITAL COMPONENTS CO., LTD., Sinjhuang City (TW)

(21) Appl. No.: 12/725,466

(22) Filed: Mar. 17, 2010

(30) Foreign Application Priority Data
Feb. 12, 2010 (TW) 099104599

(51) Int. Cl. H01M 10/50

(52) U.S. Cl. 429/120

(57) ABSTRACT

A heat-dissipating module for an automobile battery includes an automobile battery and at least one heat-dissipating device. The heat-dissipating device is adhered to one side of the automobile battery. The heat-dissipating device has a channel located to correspond to the automobile battery and a heat-absorbing surface opposite to the automobile battery. A cooling liquid is in the channel for circulation therein. The cooling liquid circulates in the channel to absorb the heat of the automobile battery to cool the battery, thereby increasing the efficiency and lifetime of the battery greatly.

This application claims the priority benefit of Taiwan patent application number 099104599 filed on Feb. 12, 2010.

### BACKGROUND OF THE INVENTION

1. Field of the Invention

The present invention relates to a heat-dissipating module, and in particular to a heat-dissipating module for an automobile battery, which is capable of cooling the automobile battery and increasing the efficiency and lifetime of the battery greatly.

2. Description of Prior Art

In a situation that a wired AC power or DC power supply cannot be used, a battery is the most common way for people to supply electricity to, such as, cars, lights, electric tools, electronic apparatuses, communication apparatuses or heat exchange apparatuses. With the change in life styles, car has become a very important transportation for our daily life.

When an automobile battery is in operation, it will be charged and discharged periodically. During this period, the temperature of the battery may rise due to the movement of electrons in the filling material of the battery. As a result, the temperature may exceed the normal working range of the battery, which substantially affects the power-supplying efficiency and lifetime of the battery.

Mostly, in a current car, a fan is provided in an engine chamber to generate airflow for heat dissipation. The fan aims to dissipate the heat of the engine and a tank. When the airflow flows in the engine chamber, the circulation of airflow can only dissipate the heat of the car but not the battery. Thus, the power-supplying efficiency and the lifetime of the battery may be deteriorated.

Therefore, it is an important issue for the present Inventor and manufacturers in this art to solve the above-mentioned problems.

### SUMMARY OF THE INVENTION

In order to solve the above problems, an objective of the present invention is to provide a heat-dissipating module for an automobile battery, in which a heat-dissipating device is directly adhered to an automobile battery to generate a good heat-dissipating effect.

Another objective of the present invention is to provide a heat-dissipating module for an automobile battery, in which a liquid-cooling device drives a cooling liquid to flow and absorb the heat of the battery, thereby generating a good heat-dissipating effect.

In order to achieve the above objectives, the present invention further provides a heat-dissipating module for an automobile battery, which includes an automobile battery and at least one heat-dissipating device. The heat-dissipating device is adhered to one side of the automobile battery. The heat-dissipating device has a channel in which a cooling liquid circulates. The channel is located at a position corresponding to the automobile battery. The heat-dissipating device has a heat-absorbing surface opposite to the automobile battery. The cooling liquid circulates in the channel to absorb the heat of the automobile battery to which the heat-dissipating device is adhered. In this way, the automobile battery can be cooled, so that the efficiency and lifetime of the battery can be increased greatly.

The present invention has advantageous features of (1) cooling the automobile battery, (2) increasing the lifetime of the battery, and (3) increasing the efficiency of the battery.

### BRIEF DESCRIPTION OF THE DRAWINGS

FIG. 1 is an exploded perspective view showing a heat-dissipating module for an automobile battery according to the present invention;

FIG. 2 is an assembled perspective view showing the heat-dissipating module for an automobile battery according to the present invention;

FIG. 3 is a schematic view showing the operating state of the heat-dissipating module for an automobile battery according to the present invention;

FIG. 4 is an exploded perspective view showing another heat-dissipating module for an automobile battery according to the present invention;

FIG. 5 is a schematic view showing the operating state of another heat-dissipating module for an automobile battery according to the present invention; and

FIG. 6 is a cross-sectional view showing another heat-dissipating module for an automobile battery according to the present invention.

### DETAILED DESCRIPTION OF THE INVENTION

The above objectives and structural and functional features of the present invention will be described in more detail with reference to preferred embodiments thereof shown in the accompanying drawings

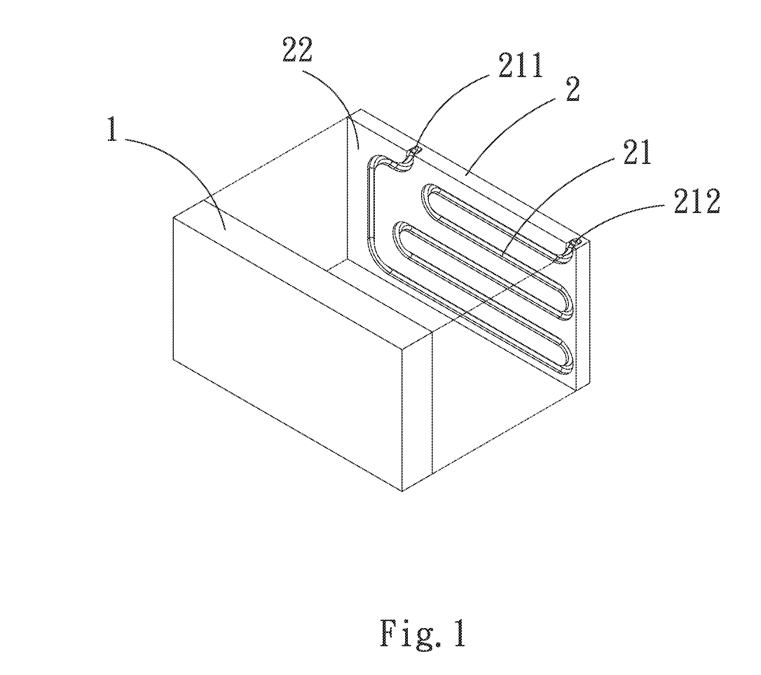

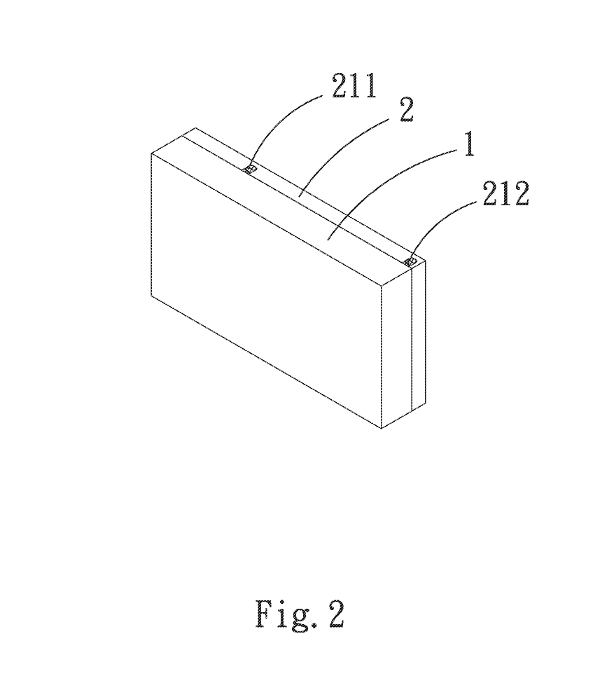

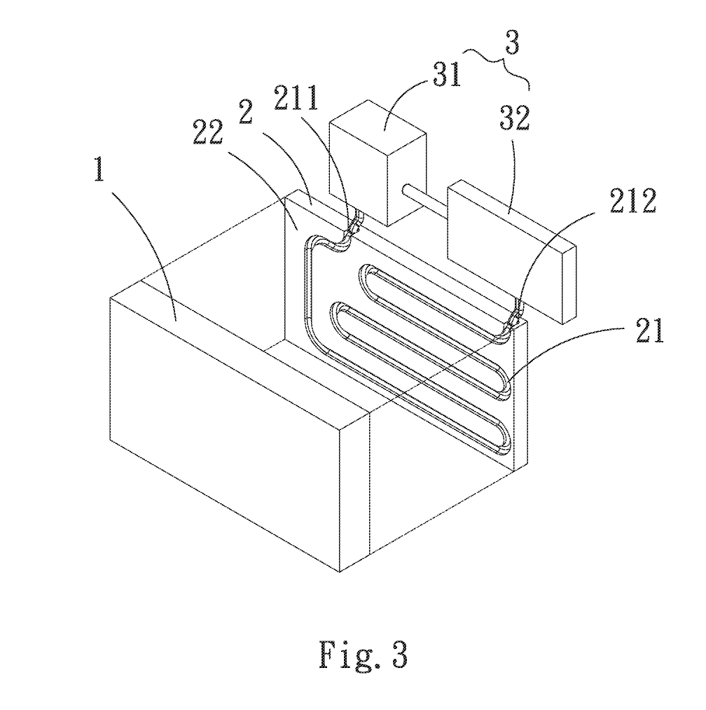

Please refer to FIGS. 1, 2 and 3. The present invention is related to a heat-dissipating module for an automobile battery 1. In a preferred embodiment of the present invention, the heat-dissipating module includes an automobile battery 1 and at least one heat-dissipating device 2. The heat-dissipating device 2 has a metallic plate of good thermal conductivity adhered to one side of the automobile battery 1. The heat-dissipating device 2 is formed with a channel 21 and a heat-absorbing surface 22. The channel 21 is formed at a position corresponding to the automobile battery 1. The heat-absorbing surface 22 is formed on one side surface of the heat-dissipating device 2 opposite to the automobile battery 1. In the present embodiment, the channel 21 is formed on the heat-absorbing surface 22 and has an open side penetrating the heat-absorbing surface 22 to correspond to the automobile battery 1. Both ends of the channel 21 are in communication with an inlet 211 and an outlet 212. The inlet 211 and the outlet 212 are connected to a pump 31 and a tank 32 of a liquid-cooling device 3 respectively.

In the liquid-cooling device 3, the pump 31 drives a cooling liquid in the tank 32 to enter the channel 21 via the inlet 211, and then the cooling liquid passes through the channel 21 to flow back into the tank 32 via the outlet 212, thereby forming a circuit. When the cooling liquid flows through the channel 21, the cooling liquid takes away the heat of the automobile battery 1 and the heat absorbed by the heat-absorbing surface 22 from the automobile battery 1. In this way, the heat of the automobile battery 1 can be absorbed and thus cooled by the heat-dissipating device 2, thereby increasing the efficiency and lifetime of the battery greatly.

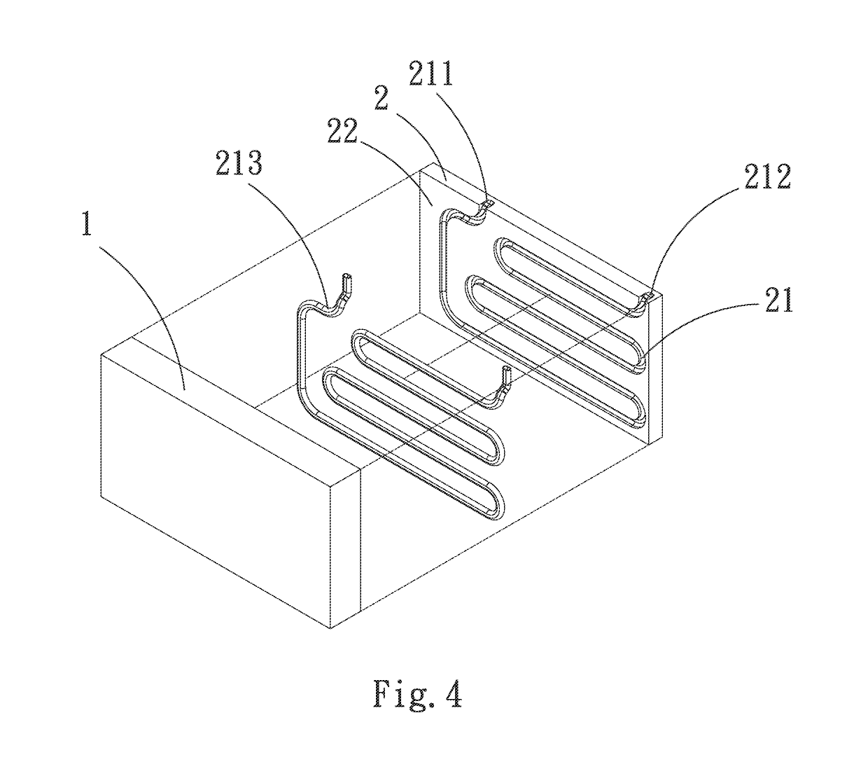

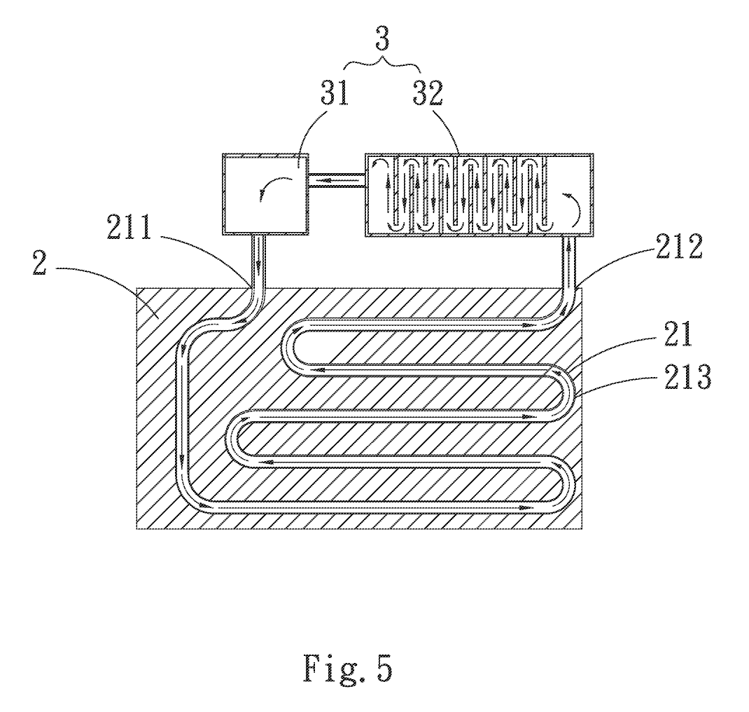

Please refer to FIGS. 4 and 5, which show another preferred embodiment. The elements, connection and operation of the present embodiment are substantially the same as those in the previous embodiment, and the only difference lies in that: a pipe 213 is provided in the channel 21. One side of the pipe 213 corresponds to the open side of the channel 21 to be adhered to the automobile battery 1.

Both ends of the pipe 213 are in communication with the inlet 211 and the outlet 212 respectively. The inlet 211 and the outlet 212 are connected to a pump 31 and a tank 32 of a liquid-cooling device 3 respectively.

In the liquid-cooling device 3, the pump 31 drives a cooling liquid in the tank 32 to enter the channel 213 via the inlet 211. The cooling liquid passes through the channel 213 to take away the heat of the automobile battery 1.

Further, when the cooling liquid flows in the channel 213, the cooling liquid also takes away the heat of the heat-absorbing surface 22 absorbed from the automobile battery 1.

In the present embodiment, not only the heat-absorbing surface 22 is used to conduct the heat of the automobile battery 1, but also the pipe 213 in the channel 21 is used to dissipate the heat of the automobile battery 1 and the heat-absorbing surface 22. In this way, the heat-dissipating device 2 can absorb the heat generated in the operation of the automobile battery and cool down the battery, thereby increasing the efficiency and lifetime of the battery greatly.

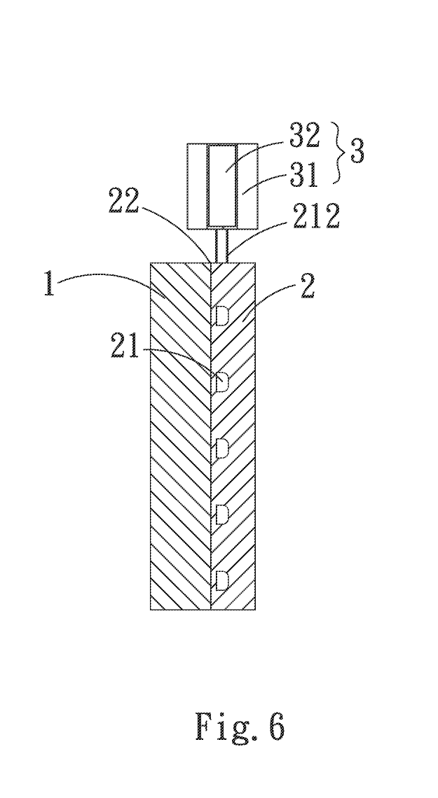

Please refer to FIG. 6, which is another preferred embodiment of the present invention. The heat-absorbing surface 22 of the heat-dissipating device 2 is formed on the surface of the heat-dissipating device 2 to which the automobile battery 1 is adhered. The channel 21 of the heat-dissipating device 2 is formed at a location corresponding to the automobile battery 1. In the present embodiment, the channel 21 penetrates into the heat-dissipating device 2 and has a closed surface opposite to the heat-absorbing surface 22 (FIG. 5). Both ends of the channel 21 are in communication with the inlet 211 and the outlet 212 respectively. The inlet 211 and the outlet 212 are connected to a pump 31 and a tank 32 of a liquid-cooling device 3 respectively. In the liquid-cooling device 3, the pump 31 drives the cooling liquid in the tank 32 to enter the pipe 213 via the inlet 211. When the heat-absorbing surface 22 absorbs the heat generated in the operation of the automobile battery 1, the cooling liquid flows through the pipe 213 to take away the heat of the heat-absorbing surface 22, thereby lowering the temperature of the automobile battery 1. In this way, the efficiency and lifetime of the automobile battery 1 can be increased greatly.

Further, the heat-dissipating device 2 of the present invention can be a vapor chamber or heat diffusion plate.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A heat-dissipating module for automobile battery, including:
an automobile battery; and
at least one heat-dissipating device adhered to one side of the automobile battery, the at least one heat-dissipating device having a channel located to correspond to the automobile battery and a heat-absorbing surface on its one side opposite to the automobile battery.

2. The heat-dissipating module for automobile battery according to claim 1, wherein the channel is provided on the heat-absorbing surface and has an open side penetrating the heat-absorbing surface to correspond to the automobile battery.

3. The heat-dissipating module for automobile battery according to claim 2, wherein a pipe is provided in the channel, and the channel corresponds to the automobile battery.

4. The heat-dissipating module for automobile battery according to claim 1, wherein the channel penetrates into the heat-dissipating device, a closed surface is formed opposite to the heat-absorbing surface.

5. The heat-dissipating module for automobile battery according to claim 1, wherein both ends of the channel are in communication with an inlet and an outlet respectively.

6. The heat-dissipating module for automobile battery according to claim 5, wherein the inlet and the outlet are connected to at least one liquid-cooling device.

7. The heat-dissipating module for automobile battery according to claim 6, wherein the liquid-cooling device includes a tank and a pump connected to the inlet and the outlet respectively.

8. The heat-dissipating module for automobile battery according to claim 1, wherein a cooling liquid is in the channel.
